(19) United States
(12) Patent Application Publication
(10) Pub. No.: US 2010/0007748 A1
(43) Pub. Date: Jan. 14, 2010

(54) Imaging apparatus and imaging method

(75) Inventor: Tomoyuki Suzuki, Yokohama-shi (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: Victor Company of Japan, Ltd., Yokohama-shi (JP)

(21) Appl. No.: 12/456,998

(22) Filed: Jun. 25, 2009

(30) Foreign Application Priority Data
Jul. 8, 2008 (JP) JP 2008-177458

(51) Int. Cl. H04N 5/228

(52) U.S. Cl. 348/208.14; 348/E05.031

(57) ABSTRACT

While an image of an object is taken and image data of the image is generated by an imaging apparatus, at least either a panning or tilting movement of the imaging apparatus is detected. Form the image data, a feature of one or more humans is detected. Moving speeds of the one or more humans in the image data are calculated. Imaging control procedures with at least either a focus or exposing adjustment are performed to the human moving at the calculated minimum speed when at least either the panning or tilting movement of the imaging apparatus is detected.

### CROSS-REFERENCE TO RELATED APPLICATIONS

This application is based on and claims the benefit of priority from the prior Japanese Patent Application No. 2008-177458 filed on Jul. 8, 2008, the entire contents of which is incorporated herein by reference.

### BACKGROUND OF THE INVENTION

The present invention relates to an imaging apparatus and an imaging method provided with imaging control functions, such as, focus and exposure adjustments.

A specific type of imaging apparatus, such as a camcorder or a video camera, is equipped with imaging control modes, such as, an autofocus (AF) mode for automatic focusing on a main target for which an image is to be taken and an auto exposure (AE) mode for automatic exposure adjustments depending on shutter speed or aperture. Such a specific type of imaging apparatus is capable of taking a clear image of an object with the AF and/or AE modes to adjust imaging conditions.

The AF and AE modes are performed for a target positioned at a specific distance from an imaging apparatus. Such an object is usually a human or another object selected by a user of the imaging apparatus.

The following are several known techniques for the AF and AE modes.

One technique is continuous focusing on a target in response to shaking of an imaging apparatus or the movement of the target with a repeated procedure of determining an in-focus position using a plurality of images and shifting an imaging lens to a determined in-focus position.

Another technique is focus adjustments to a small or a moving target in the picture including a stationary object, for which an image is being taken. The picture is divided into several small zones, followed by integration of high-frequency components in each divided zone, and focus is made on a zone to which motion vectors converge.

Still, another technique is to apply weighting to facial data of humans, from which a particular human is to be identified, depending on their sizes and positions, in order to select facial data of the largest weighting as a primary target for which an image should be taken.

A further technique is to detect a motion of an imaging apparatus with a built-in angular speed sensor while the imaging apparatus is being panned and/or tilted, to adjust a position of a face-detecting frame based on the detected motion level.

According to the known techniques, even a small object is correctly and automatically focused when an imaging apparatus is fixed. Nevertheless, such an automatically focused object may not always be the target for a user of an imaging apparatus who wants to take an image. Or, focus is made on an object that is moving very much or that occupies a large part of a picture, so that an out-of focus image is taken for the target for which a user wants to take an image.

Moreover, in the known adjustment technique for a face-detecting frame position, the frame is shifted relative to a reference frame depending on the movement of an imaging apparatus that is being panned and/or tilted, which may not always be applied to a target.

Accordingly, in the known techniques, a target may not always be determined or in in-focus, or focus may be made for another object that occupies a large part of a picture or that is positioned in the center of a picture. For instance, when a user try to take an image of a human who is running while dribbling a ball in football, unless the human's face is the largest and the human is positioned in the center of a picture, another object is erroneously determined as a primary target for which an image should be taken, resulting in an undesired image being taken.

### SUMMARY OF THE INVENTION

A purpose of the present invention is to provide an imaging apparatus and an imaging method to generate image data of high quality, by accurately and speedily determining a target for which a user wants to take an image, through imaging procedures based on user's intention even when the imaging apparatus is being panned and/or tilted by the user.

The present invention provides an imaging apparatus comprising: a movement detector to detect at least either a panning or tilting movement of the imaging apparatus; an imager to take an image of an object and generate image data of the image thus taken; a human-feature extractor to extract a feature of one or more humans from the image data; a moving-speed calculator to calculate moving speeds of the one or more humans in the image data; and an imaging controller to perform imaging control procedures with at least either a focus or exposing adjustment to a human moving at an minimum speed calculated by the moving-speed calculator when at least either the panning or tilting movement of the imaging apparatus is detected by the movement detector.

Moreover, the present invention provides an imaging method for taking an image of an object by an imaging apparatus comprising the steps of: detecting at least either a panning or tilting movement of the imaging apparatus; taking an image of an object and generate image data of the image thus taken; extracting a feature of one or more humans from the image data; calculating moving speeds of the one or more humans in the image data; and performing imaging control procedures with at least either a focus or exposing adjustment to a human moving at a calculated minimum speed when at least either the panning or tilting movement of the imaging apparatus is detected.

### BRIEF DESCRIPTION OF DRAWINGS

FIG. 1 shows an exterior view of an imaging apparatus according to the present invention;

FIG. 2 shows a view illustrating the movements of the imaging apparatus according to the present invention in accordance with user's intention;

FIG. 3 shows a circuit block diagram for the imaging apparatus according to the present invention;

FIG. 4 shows a view illustrating the relation between the panning and tilting movements of the imaging apparatus and the moving speeds of humans in an image taken by the imaging apparatus; and

FIG. 5 shows a flowchart used in an imaging method according to the present invention.

### DETAILED DESCRIPTION OF PREFERRED EMBODIMENTS

Preferred embodiments according to the present invention will be disclosed with reference to the drawings attached herewith.

A purpose of the embodiments which will be described below is to accurately and speedily determine a human who is the target a user of an imaging apparatus wants to take an image of while the imaging apparatus is being panned and/or tilted by the user.

[Imaging Apparatus]

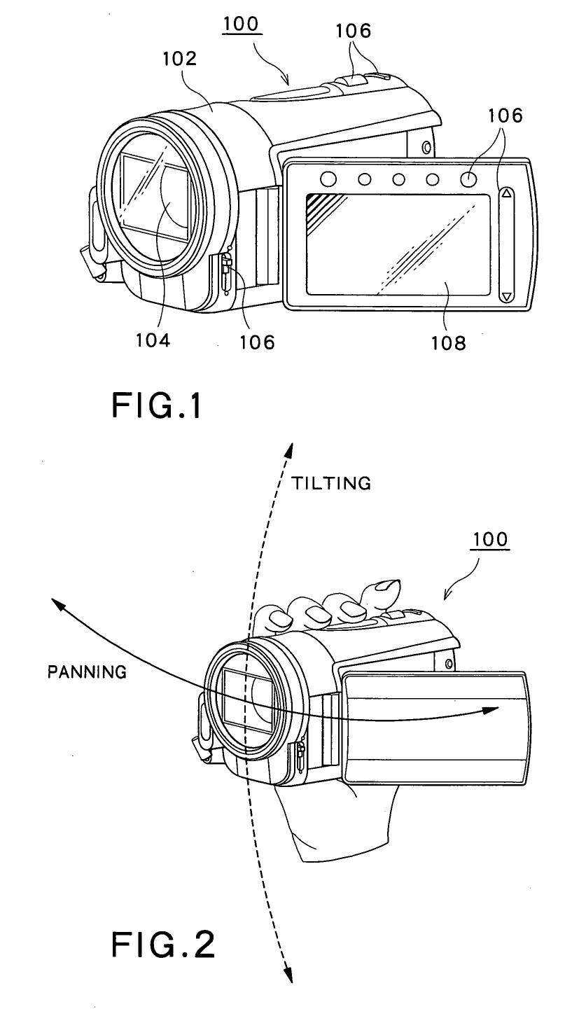

As shown in FIG. 1, an imaging apparatus 100, an embodiment of the present invention, which is mostly potable, is equipped with an imaging lens 104, operation keys 106, and a view finder 108, attached to a main body 102.

The main body 102 is equipped with a built-in mechanism for reproducibly recording image data taken through the imaging lens 104 at a specific recording timing, view angle, etc., entered by a user with the operation keys 106, with AF and AE adjustments to a target in the image data.

The view finder 108 is constituted by a liquid crystal display, an organic EL (Electro Luminescence), etc., to allow a user to view image data to be recorded so that he or she can take an image of a target at a desired position and size.

The imaging apparatus 100 can be used not only when a user holds it at a fixed position but also when he or she moves it to change the direction of the imaging lens 104 to follow a moving target. Expected movements of the imaging apparatus 100 are panning and tilting as illustrated by solid and lines, respectively, in FIG. 2.

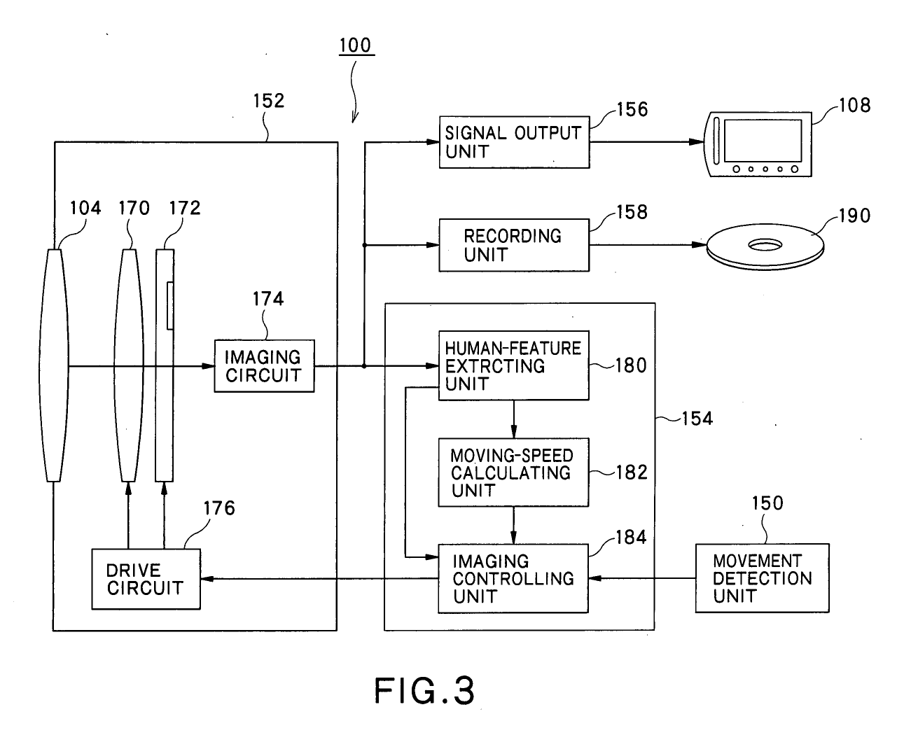

Shown in FIG. 3 is a circuit block diagram for the imaging apparatus 100.

The imaging apparatus 100 is mainly equipped with a movement detection unit 150, an imaging unit 152, a central controlling unit 154, a signal output unit 156, and a recording unit 158.

The movement detection unit 150 is constituted by sensors, such as, an angular accelerometer, an angular rate sensor, an accelerometer, and a tilt sensor, and an arithmetic unit for obtaining an angular rate or velocity based on detection signals output from the sensors.

The movement detection unit 150 detects the movements of the imaging apparatus 100 in panning and/or tilting when a user moves the imaging apparatus 100 in the directions illustrated in FIG. 2 to follow a moving target such as a human.

The angular accelerometer and/or the angular rate sensor may also be used for an anti-shake mechanism for correcting an out-of focus image due to hand shaking. When these angular sensors are shared by the movement detection unit 150 and the anti-shake mechanism, the three types of movement are determined: a hand-shaking movement when the detected direction is changing in left and right, and also up and down; a panning movement when it is changing in left and right only; and a tilting movement when it is changing in up and down only.

The imaging unit 152 takes an image of an object through the imaging lens 104 and generates image data. The imaging unit 152 is mainly constituted by: a focusing lens 170 for focus adjustments; an aperture 172 for exposure adjustments; an imaging circuit (imaging device) 174 for converting light incident through the imaging lens 104 and the aperture 172 into an electric signal; and a drive circuit 176 for driving the focusing lens 170 and the aperture 172.

The image data generated by the imaging unit 152 is sent to the central controlling unit 154, the signal output unit 156, and the recording unit 158.

The central controlling unit 154 is constituted by a semiconductor integrated circuit that includes a central processing unit (CPU), a digital signal processor (DSP), etc., for the entire management and control of the imaging apparatus 100.

Also integrated into the central controlling unit 154 are a human-feature extracting unit 180, a moving-speed calculating unit 182, and an imaging controlling unit 184.

The human-feature extracting unit 180 continuously checks if there are one or more humans in a picture of image data. Especially, the extracting unit 180 continuously checks if there are one or more faces of humans in a picture of image data. And if so, the extracting unit 180 extracts one or more positions of the faces and sends the checked result to the imaging controlling unit 184 and positional data to the moving-speed calculating unit 182.

The human-feature extracting unit 180 can perform the check on face with a face recognition algorism to recognize the feature of face, such as, the skin color, the face line, the arrangement pattern of the eyes, nose, and mouth. Moreover, not only the face, the extracting unit 180 can detect a human based on the human's bodyline, the movement of human's body (hands, legs, and the like), etc.

On receiving the positional data on one or more of humans (indicating the position of human's face, body, hands, legs, etc.), the moving-speed calculating unit 182 calculates the moving speeds of one or more of humans in the direction to up, down, right or left in a picture of the image data.

The speed calculation can be performed with motion vectors, or the number of pixels shifted per unit of time for one or more of humans who are moving. The number of pixels shifted per unit of time allows numerical comparison of humans' moving speeds to accurately and speedily catch a human of the minimum moving speed, as the human target whom a user is trying to take an image of.

Nevertheless, the numerical comparison of humans' moving speeds based on the number of pixels shifted per unit of time may sometimes cause misjudgment of the target human, whom a user is trying to take an image of, at the imaging controlling unit 184, the function of which will be described later. Because the judgment at the controlling unit 184 depends on the distance from the imaging apparatus 100. For example, the image of a human located farther than a target human from the imaging apparatus 100 may give a smaller number of pixels shifted per unit of time than that of the image of the target human.

Such misjudgment can be avoided by applying weighting to the moving speeds of humans calculated by the moving-speed calculating unit 182, depending on the distance of the humans from the imaging apparatus 100. For example, the moving speeds of humans are multiplied by coefficients, the farther from the imaging apparatus 100, the larger the coefficient. The weighting thus offers appropriate numerical comparison of humans' moving speeds.

The calculated and weighted moving speeds are sent to the imaging controlling unit 184. Also supplied to the controlling unit 184 is information on panning and/or tilting movements of the imaging apparatus 100 if detected by the movement detection unit 150. Whenever at least either the panning or tilting movement is detected, and during the movement, the controlling unit 184 performs imaging control procedures with focus and/or exposure adjustments to a human of the minimum moving speed as the main target. The controlling unit 184 then sends a control command for the imaging control procedures to the drive circuit 176 of the imaging unit 152.

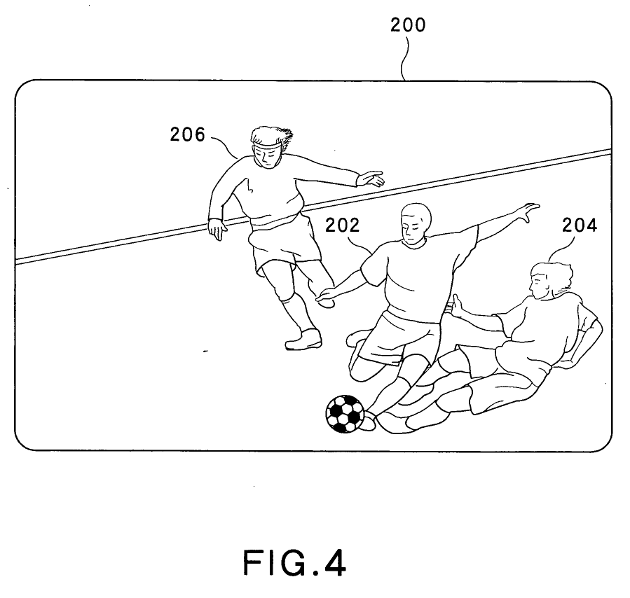

Illustrated in FIG. 4 is the relation between the panning and tilting movements of the imaging apparatus 100 and moving speeds of humans moving in an image taken by the imaging apparatus 100. FIG. 4 shows an image 200 taken by the imaging apparatus 100 in which humans 202, 204, and 206 are playing football.

Suppose that a user is taking an image of the human 202 as the main target and following the movement of the human 202, so that he or she pans and/or tilts the imaging apparatus 100.

In the known techniques already described, the human 206 located almost the center in the image 200 is erroneously recognized as the main target for imaging procedures due to no specific procedure being made to the panning and/or tilting movements.

Different from the known techniques, it is the basic principle of the present invention that, when a user follows the movement of a particular object as the main target, he or she pans and/or tilts the imaging apparatus 100 in almost the same direction in which the main target is moving.

Therefore, no matter where the human 202 (the main target) is located or moving in the image 200, the moving speed of the human 202 in the image 200 is the minimum among the three humans 202, 204 and 206. The moving speed of the human 202 is theoretically zero when a user pans and/or tilts the imaging apparatus 100 exactly at the same timing as the movement of the human 202.

Accordingly, in the present invention, the human 202 of the minimum moving speed can be recognized as the main target when the imaging apparatus 100 is panned and/or tilted, thus high-quality image data being generated in which the human 202 is well focused.

As described above, the present invention has two requirements: (1) detection of a human moving at the minimum moving speed in an image taken; and (2) detection of panning and/or tilting movements of the imaging apparatus 100.

Suppose that the requirement (2) discussed above is not applied to the fixed imaging apparatus 100 and a human is moving from right to left in the image 200, who is the main target for a user to take an image of. In this situation, the imaging control procedures are not applied to the main target human but to another human if he or she is moving in the image 200 at a speed slower than the main target human.

It is practically quite difficult to determine the main target for a user without the requirement (2). And, application of the imaging control procedures to the human of the minimum speed without the requirement (2) may go against the user's intention.

Therefore, the imaging apparatus 100 (FIG. 3) has another requirement (3) in that the imaging controlling unit 184 does not function while the movement detection unit 150 is not detecting at least either the panning or tilting movement.

Even in such a situation under the requirement (3) discussed above, the signal output unit 156 processes the image data supplied from the imaging unit 152 into a viewable image signal and sends the signal to the view finder 108. Then, a user can focus onto a particular object while viewing the image of the view finder 108. The viewable image signal may be sent to another displaying means such as a separate monitor.

The viewable image signal generated by the signal output unit 156 is also sent to the recording unit 158 in which the image signal is encoded into a data stream. The data stream is then stored in a storage medium 190, such as, DVD and BD that require no power supply, or RAM, EEPROM, non-volatile RAM, flash memory, and HDD that require power supply. A separate storage medium may also be used to store the data stream.

[Imaging Method]

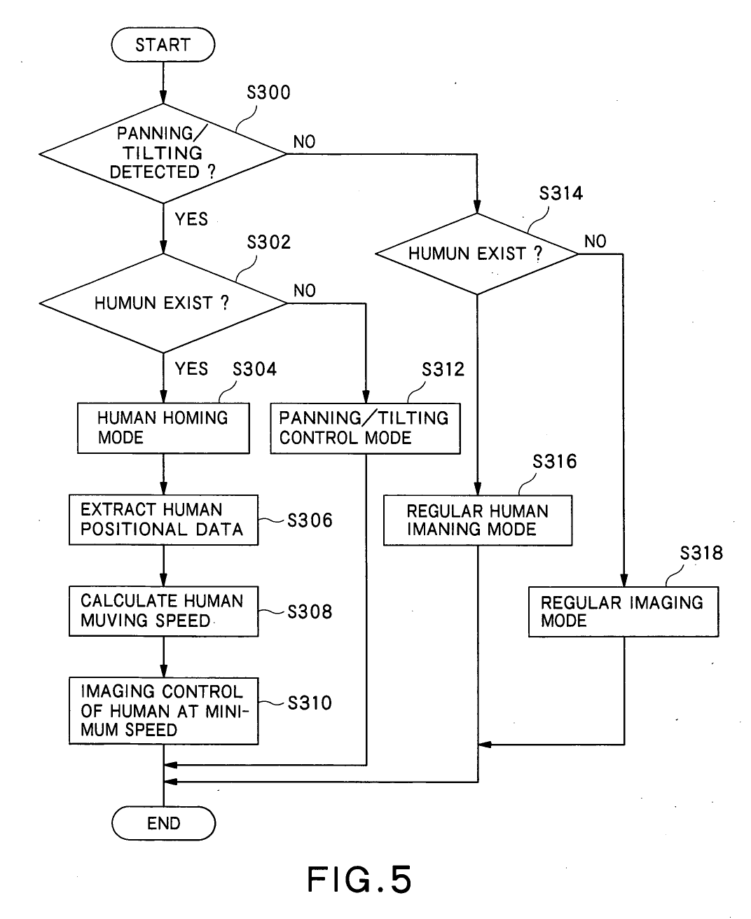

Disclosed next with reference to FIG. 5 is an imaging method with imaging procedures, such as, focus and exposure adjustments, by using the imaging apparatus 100 described above.

In a flowchart of FIG. 5, when a user starts imaging by using the imaging apparatus 100, the movement detection unit 150 continuously detects whether the imaging apparatus 100 is at least either the panning or tilting movement (S300).

When the movement detection unit 150 detects at least either the panning or tilting movement of the imaging apparatus 100 (YES in S300), the human-feature extracting unit 180 determines whether there are one or more humans in the image data generated by the imaging unit 152 (S302).

When the human-feature extracting unit 180 determines that there are one or more humans in the image data (YES in S302), the procedure enters a human homing mode (S304).

In the human homing mode, the human-feature extracting unit 180 extracts positional data of one or more humans in the image data (S306).

The moving-speed calculating unit 182 receives the positional data and calculates the moving speeds of one or more of humans (S308).

When the moving speeds of one or more of humans are calculated, and since at least either the panning or tilting movement has been detected (YES in S300), the imaging controlling unit 184 performs imaging control procedures with focus and/or exposure adjustments to the human of the minimum moving speed as a main target (S310).

On the contrary, even when at least either the panning or tilting movement has been detected (YES in S300), if no humans have been detected in the image data (NO in S302), the procedure enters a regular panning/tilting control mode of imaging control procedures with focus and/or exposure adjustments to a predetermined point in the image data, for example, the center of a picture in the image data (S312).

In the regular panning/tilting control mode, the imaging controlling unit 184 performs the imaging control procedures based on the image data generated by the imaging unit 152.

When none of the panning and tilting movements has been detected (NO in S300), the human-feature extracting unit 180 also determines whether there are one or more humans in the image data generated by the imaging unit 152 (S314).

When the human-feature extracting unit 180 determines that there are one or more humans in the image data (YES in S314), the procedure enters a regular human imaging mode (S316).

In the regular human imaging mode, the imaging controlling unit 184 performs the imaging procedures to the human who occupies a larger area in the image data or is located in the center of the image data (S316).

On the contrary, when the human-feature extracting unit 180 determines that there are no humans in the image data (NO in S314), the procedure enters a regular imaging mode (S318).

In the regular imaging control mode, the imaging controlling unit 184 performs the imaging control procedures based on the image data generated by the imaging unit 152.

As described above, also in the imaging method, a particular human can be accurately identified as a main target for a user under the two requirements: (1) detection of a human moving at the minimum moving speed in an image taken; and (2) detection of panning and/or tilting movements of the imaging apparatus 100. Thus, the imaging method can also achieve the imaging control in accordance with user's intention.

It is further understood by those skilled in the art that the forgoing description is a preferred embodiment of the disclosed apparatus and method and that various changes and modifications may be made in the invention without departing from the spirit and scope thereof.

For example, the flowchart shown in FIG. 5 may have a different order of the steps and also may have other parallel routines or subroutines.

As disclosed above, in detail, the present invention can provide high-quality image data, by accurately and speedily determining an object that is the target a user wants to take an image of, through imaging procedures based on user's intention even when the imaging apparatus is being panned and/or tilted.

What is claimed is:

1. An imaging apparatus comprising:
a movement detector to detect at least either a panning or tilting movement of the imaging apparatus;
an imager to take an image of an object and generate image data of the image thus taken;
a human-feature extractor to extract a feature of one or more humans from the image data;
a moving-speed calculator to calculate moving speeds of the one or more humans in the image data; and
an imaging controller to perform imaging control procedures with at least either a focus or exposing adjustment to a human moving at an minimum speed calculated by the moving-speed calculator when at least either the panning or tilting movement of the imaging apparatus is detected by the movement detector.

2. The imaging apparatus according to claim 1, wherein the moving-speed calculator calculates the moving speeds in accordance with the number of pixels shifted per unit of time for the one or more humans moving in the image data.

3. An imaging method for taking an image of an object by an imaging apparatus comprising the steps of:
detecting at least either a panning or tilting movement of the imaging apparatus;
taking an image of an object and generate image data of the image thus taken;
extracting a feature of one or more humans from the image data;
calculating moving speeds of the one or more humans in the image data; and
performing imaging control procedures with at least either a focus or exposing adjustment to a human moving at a calculated minimum speed when at least either the panning or tilting movement of the imaging apparatus is detected.

4. The imaging method according to claim 3, wherein the moving speeds are calculated in accordance with the number of pixels shifted per unit of time for the one or more humans moving in the image data.
